(19) United States
(12) Patent Application Publication
(10) Pub. No.: US 2011/0168502 A1
(43) Pub. Date: Jul. 14, 2011

(54) COMBINED VEHICLE BRAKE SYSTEM WITH HYDRAULICALLY AND ELECTROMECHANICALLY ACTUATABLE WHEEL BRAKES

(75) Inventors: Paul Linhoff, Neu-Anspach (DE); Andreas Heise, Erzhausen (DE)

(73) Assignee: CONTINENTAL TEVES AG & CO. OHG, Frankfurt (DE)

(21) Appl. No.: 13/062,976

(22) PCT Filed: Sep. 21, 2009
(86) PCT No.: PCT/EP2009/062166

§ 371 Date: Mar. 9, 2011

(30) Foreign Application Priority Data
Sep. 27, 2008 (DE) 10 2008 049 218.3
Sep. 16, 2009 (DE) 10 2009 041 449.5

(51) Int. Cl. F16D 55/22; B60T 13/66

(52) U.S. Cl. 188/72.2; 303/3

(57) ABSTRACT

A combined vehicle brake system, in particular for a motor vehicle, includes an electromechanical service brake system for a front axle of the vehicle. The electromechanical brake system has at least one electromechanically actuatable wheel brake (2). The combined brake system also includes a hydraulic service brake system for a rear axle of the vehicle. The hydraulic brake system a master brake cylinder (4) and at least one hydraulically actuatable wheel brake (1).

### TECHNICAL FIELD OF THE INVENTION

The invention relates to a combined hydraulic and electromechanical vehicle brake system. The vehicle brake system is provided for use in motor vehicles, in particular in automobiles.

### BACKGROUND OF THE INVENTION

Electromechanical brakes that are actuatable directly by electromechanical means, for example by means of an electric motor, are known. For example, DE 196 15 186 C1 describes a brake system in which each wheel brake has an associated electric motor with a rotor. Upon activation of the electric motor, the rotary motion of the rotor is converted into a translational motion by means of a spindle. Through a mechanical transmission in the form of a lever mechanism, the axial force is multiplied and transmitted to a piston which presses a brake pad against a brake disk and generates a braking moment. It is provided that all (four) wheels of a vehicle are equipped with such an electromechanical wheel brake. The disadvantage of such fully electromechanical brake systems is that, in order to ensure the necessary redundancy, in particular the emergency energy supply, the usual vehicle on-board network is not sufficient and two additional backup batteries provided only for the brake system are necessary. Furthermore, to provide a reliable energy supply, an increase in the voltage of these batteries (as compared to the usual on-board network voltage of 12 V) to voltages of, for example, 36 V or 42 V is required. Only in this way can a sufficient quantity of energy for the electric motors be made available quickly and reliably.

Furthermore, electrohydraulic brake systems in which the wheel brake is subjected to the hydraulic pressure from an externally actuatable pressure source are known. Such brake systems generally require costly and complex hydraulic components, for example a high-pressure accumulator, and include for additional brake components in case of failure of the electrohydraulic brake (fallback level). For example, a brake system with an electrohydraulic brake on the front axle and an electromechanical brake on the rear axle is known from DE 100 10 735 A1. In normal operation the electrohydraulic brake is subjected to the hydraulic pressure from an externally actuatable pressure source. As the externally actuatable pressure source, a motor-pump unit with a high-pressure accumulator is used. For emergency operation the brake system additionally includes a further, driver-actuatable pressure source. Because of the complex and costly hydraulic components and the additional components for emergency operation, electrohydraulic brake systems are very expensive.

In addition, hydraulic brake systems as well as combined brake systems comprising an electromechanical brake system for the rear axle and a hydraulic brake system for the front axle are known. For example, a brake system in which a hydraulic service brake system is used on the front axle and an electromechanical service brake system is used on the rear axle is known from DE 103 19 194 B3, wherein the brake pressure for the hydraulic brake system of the front axle is generated by a driver-actuatable brake master cylinder and a vacuum brake booster. A disadvantage of the above-mentioned brake systems is that the hydraulic brake on the front wheels must usually be implemented with vacuum assistance in order to obtain sufficient hydraulic brake pressure. Accordingly, these systems additionally require a vacuum booster which boosts the braking request effected hydraulically by the driver by means of a vacuum from an internal combustion engine or a vacuum pump.

### SUMMARY OF THE INVENTION

It is therefore the object of the present invention to provide an alternative vehicle brake system which is cost-effective and requires neither a brake booster nor vacuum assistance.

This object is achieved according to the invention by a vehicle brake system implementing the service brake system for the front axle of the vehicle as an electromechanical service brake system and the service brake system for the rear axle of the vehicle as a hydraulic service brake system.

The invention offers the advantage, firstly, that the hydraulic service brake system can be implemented without vacuum assistance, since the braking force demand is generally lower on the rear axle than on the front axle. Secondly, the brake system with electromechanical brakes places a demand on the energy supply only at the front axle of the vehicle. This energy supply can be delivered by a usual vehicle on-board network. Costs incurred through additional batteries can therefore be avoided with the brake system according to the invention. A further advantage is that the brake system can deliver sufficient braking power via the rear axle even in the event of failure of the on-board network.

The electromechanically actuatable wheel brakes on the front axle are preferably disk brakes. Electromechanically actuatable disk brakes are known per se from the state of the art. Except for possible slight modifications, suitable electromechanically actuatable disk brakes are therefore already available and can therefore be used cost-effectively in a brake system according to the invention. The braking forces which can be exerted on the front axle with electromechanically actuatable wheel brakes are sufficient, in particular, for not unduly heavy vehicles, such as electric vehicles and small and medium-sized automobiles.

It is also preferred to assist the braking effect on the front axle with the braking effect of an electric drive motor of the vehicle which is operated in generator mode (recuperation). This has the consequence that the electromechanically actuatable disk brakes do not need to be designed to be very large and powerful.

The hydraulically actuatable wheel brakes on the rear axle are preferably self-energizing brakes, for example wedge brakes or drum brakes, or over-dimensioned disk brakes, that is, disk brakes with a large effective radius. In this way a sufficient braking effect can be achieved even without brake force boosting. The hydraulically actuatable wheel brakes on the rear axle are, especially preferably, drum brakes, since drum brakes per se are already widely used and are therefore technically mature, and can generate higher braking forces for the same application force than disk brakes, for example. Brake force boosting, in particular a vacuum brake booster, is therefore unnecessary.

In an especially advantageous development of the subject matter of the invention, it is provided that the vehicle brake system includes a brake actuating device which can be actuated by a vehicle driver and which is connected directly upstream of the brake master cylinder of the hydraulic service brake system, without an interposed brake booster. During unregulated braking, the hydraulically actuatable wheel brakes are subjected to the hydraulic pressure induced by the driver via the brake actuating device and via a brake master cylinder connected downstream thereof without an interposed brake booster. The omission of a brake booster leads to a lowering of the cost of the brake system.

The vehicle brake system advantageously includes an electrohydraulic control unit which is associated with the rear axle and which can execute control of the braking force of the hydraulically actuatable wheel brakes by means of a wheel brake pressure control valve arrangement. The electrohydraulic control unit preferably generates command data for controlling the braking force of the electromechanically actuatable wheel brakes and transmits said command data to the electromechanically actuatable wheel brakes. In this way a coordinated control of all the wheel brakes of the vehicle by the electrohydraulic control unit can be implemented. This is especially advantageous in the case of a slip control or electronic stability control system, or in the event of failure of one or more wheel brakes.

The electrohydraulic control unit is preferably configured in such a manner that it can subject the hydraulically actuatable wheel brakes to a hydraulic pressure without an actuation of the brake actuating device by the vehicle driver, or that it can increase a hydraulic pressure induced by the vehicle driver. For this purpose the electrohydraulic control unit preferably includes a motor-pump unit and at least one valve for building up pressure in one of the hydraulically actuatable wheel brakes.

In order to keep the length of the brake lines used short and thus to reduce manufacturing costs, the electrohydraulic control unit is preferably arranged in the rear part of the vehicle. Likewise, the brake fluid reservoir for the electrohydraulic control unit is advantageously arranged preferably in the rear part of the vehicle, in order to save installation space in the front region of the vehicle.

According to a development of the invention, the hydraulic service brake system comprises two hydraulically actuatable wheel brakes and is in the form of a single-circuit brake system with a single-circuit brake master cylinder. The electrohydraulic control unit is preferably connected to the single-circuit brake master cylinder via a single hydraulic brake line, and a respective single hydraulic brake line leads from the electrohydraulic control unit to each of the two wheel brakes. In this way cost and installation space for brake lines can be saved.

According to a development of the invention, the hydraulic service brake system comprises two hydraulically actuatable wheel brakes and is in the form of a dual-circuit brake system with a tandem brake master cylinder. In this case the electrohydraulic control unit is preferably connected to the two connections of the tandem brake master cylinder via two hydraulic brake lines. A respective single hydraulic brake line then leads from the electrohydraulic control unit to each of the two wheel brakes.

The electrohydraulic control unit preferably includes at least a sensor arrangement for detecting at least one quantity representing a yaw rate, a lateral acceleration, or a longitudinal acceleration, or is connected to such a sensor arrangement in order to be able to execute slip control or electronic stability control or both. Additionally or alternatively, the electrohydraulic control unit includes a sensor arrangement for detecting a parking brake request, or is connected to such a sensor arrangement.

The electromechanically actuatable wheel brakes are preferably actuatable according to a braking request transmitted to the wheel brakes, or according to data derived therefrom, via a vehicle bus (for example, CAN), or according to output signals of a pedal travel sensor which determines the actuation travel of a brake pedal, or according to a combination of the foregoing inputs.

A respective electronic control unit is preferably associated with each of the electromechanically actuatable wheel brakes of the front axle. This electronic control unit is preferably integrated in the associated wheel brake. This ensures a compact construction of the electromechanically actuatable wheel brake.

Each of the electronic control units is preferably connected indirectly or directly, preferably via more than one communication bus, to the electrohydraulic control unit associated with the rear axle. Each control unit of an electromechanically actuatable wheel brake can thereby receive braking force command data from the electrohydraulic control unit which performs, for example, the coordination of all the wheel brakes.

It is likewise preferred that a data bus is provided for communication between the control units of the electromechanically actuatable wheel brakes.

The electromechanically actuatable wheel brake(s) of the front axle preferably each comprise(s) a parking brake device which can be activated by the vehicle driver by means of a parking brake operating element. In order to save cost, the hydraulically actuatable wheel brake(s) of the rear axle preferably do/does not include a parking brake device or parking brake function.

The parking brake operating element is advantageously connected directly to an electronic control unit. This unit transmits the parking brake request to all electromechanically actuatable wheel brakes with parking brake devices. The parking brake operating element is connected, for example directly, to the electronic control unit of an electromechanically actuatable wheel brake. Thus, in the event of failure of the communication bus, a parking brake operation can be carried out at least on this electromechanically actuatable wheel brake.

According to a development of the invention, the brake system includes a respective wheel rotational speed sensor at least on each of the front wheels. The electronic control unit of each electromechanically actuatable wheel brake is connected directly to at least one of these wheel rotational speed sensors; especially preferably, the control unit is connected directly to the wheel rotational speed sensor of the front wheel associated therewith.

In order that the electronic control unit of an electromechanically actuatable wheel brake can carry out independent braking of the electromechanically actuatable wheel brake even in the event of loss of communication with the electrohydraulic control unit, at least information of a sensor which reproduces a driver's braking request is supplied to the electronic control unit of each electromechanically actuatable wheel brake, preferably via a further path other than the direct communication-bus connection with the electrohydraulic control unit. Said sensor is especially preferably a travel sensor or angle sensor for detecting the actuation of the brake actuating device. Alternatively or additionally, it may be a travel sensor for determining a piston travel in the brake master cylinder, or a pressure sensor for determining a hydraulic pressure in the master cylinder or in the electrohydraulic control unit.

The bus system is preferably in the form of a closed loop circuit which connects the electronic control units of the electromechanical brakes and the electrohydraulic control unit.

The brake system according to the invention requires neither a brake booster nor a vacuum assistance. For this reason, the brake system is preferably used in electric or hybrid vehicles in which a vacuum of an internal combustion engine is in principle not present, or in which a vacuum of an internal combustion engine is available only periodically.

The invention also relates to vehicles with electric drive or to hybrid vehicles with a combined drive by means of an internal combustion engine and an electric drive, which vehicles include a vehicle brake system according to the invention.

### BRIEF DESCRIPTION OF THE DRAWINGS

Further preferred embodiments of the invention are apparent from the following description with reference to figures, in which:

FIG. 1 shows schematically a circuit diagram of a first exemplary embodiment of a vehicle brake system according to the invention with hydraulically and electromechanically actuatable wheel brakes,

FIG. 2 shows schematically a circuit diagram of a second exemplary embodiment of a vehicle brake system according to the invention with hydraulically and electromechanically actuatable wheel brakes, and

FIG. 3 shows schematically a circuit diagram of a third exemplary embodiment of a vehicle brake system according to the invention with hydraulically and electromechanically actuatable wheel brakes.

### DETAILED DESCRIPTION OF THE DRAWINGS

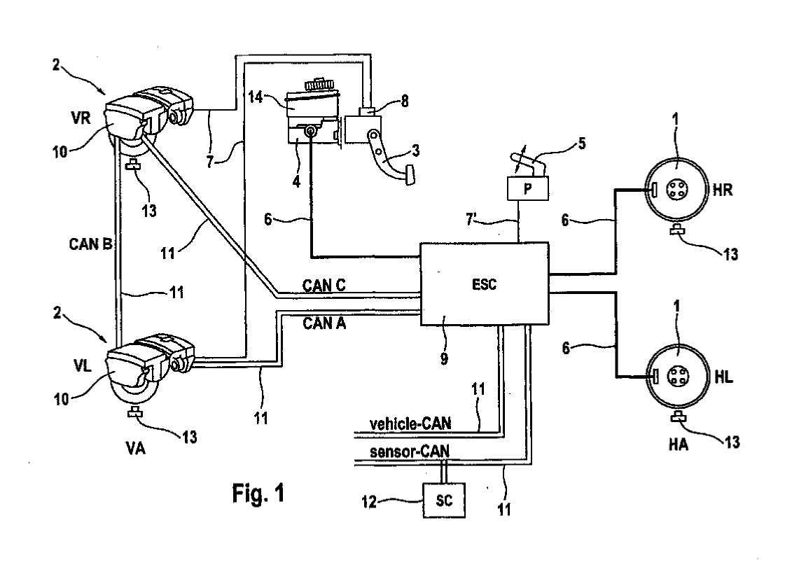

FIG. 1 shows schematically a circuit diagram of a first exemplary embodiment of a vehicle brake system according to the invention. The exemplary brake system comprises two electromechanical brake actuators 2 on the front axle VA (VR: front right, VL: front left), which, for example, each act on a respective disk brake, and a hydraulic wheel brake 1 on each of the wheels of the rear axle HA (HR: rear right, HL: rear left). The rear wheel brakes 1 are designed in such a manner that normal braking can be effected by the regular driver's foot force applied via the brake pedal 3 without additional “hydraulic” boosting.

In the example, the hydraulic wheel brakes 1 are in the form of drum brakes which are subjected to hydraulic pressure via a single brake master cylinder 4 without any vacuum assistance.

The hydraulic brake pressure for the hydraulically actuatable wheel brakes 1 is made available by a pedal-actuated single brake master cylinder 4 on one circuit for both rear wheel brakes 1. In the example, only one hydraulic brake line 6 leads from the brake master cylinder 4 to an electrohydraulic brake control unit 9 from which only one brake line 6 in each case leads to each of the two rear wheel brakes 1.

The electromechanically actuatable wheel brakes 2 are actuatable, for example, according to the hydraulic pressure induced in the hydraulically actuatable wheel brakes 1, or according to the hydraulic pressure induced by the driver (determined, for example, using an admission pressure sensor or using a piston travel sensor in the master cylinder 4). On the basis of this value the electromechanically actuatable wheel brakes 2 on the front axle are activated; that is to say that an application force of the electromechanically actuatable wheel brakes 2 is set while taking account, for example, of a brake force distribution function between front and rear axles. Furthermore, the electromechanically actuatable wheel brakes 2 may be activated according to the actuation travel of the brake pedal 3, that is, according to the request of the vehicle driver. For this purpose, in the example, the actuation travel of the brake pedal 3 is determined by means of a pedal travel sensor 8. In the example, the signal is transmitted to the electromechanically actuatable wheel brakes 2 via lines 7.

According to the example, the activation of the electromechanically actuatable wheel brakes 2 is executed locally by two electronic control units 10, which are each associated with a respective electromechanically actuatable wheel brake 2. The electromechanical brake control units 10 are, for example, integrated in the respective wheel brake 2.

In the example, the electrohydraulic control unit 9 is a control unit for an electronic stability control system (ESC control unit for two wheel brakes). In order to determine the hydraulic pressure induced and to carry out control processes, at least one pressure sensor is provided according to the example. The electrohydraulic brake control unit 9 may build up hydraulic pressure on a wheel brake 1 automatically (without admission pressure from the driver) and thereby brake the rear wheels HR, HL, as required. Alternatively or additionally, the electrohydraulic brake control unit 9 may increase an existing admission pressure from the driver, for example as determined by a known ESC control unit for electronic stability control in the case of four hydraulically actuatable wheel brakes.

A so-called sensor cluster SC comprising at least a yaw rate sensor arrangement (detection of rotation about the vertical axis of the vehicle) and a lateral acceleration sensor arrangement, and optionally a longitudinal acceleration sensor arrangement, may be in the form of a separate module 12 (as represented in FIG. 1), or may be accommodated in the electrohydraulic control unit 9 (not represented). Electronic stability control can be performed with reference to the sensor signals of the sensor cluster SC. With a normal braking function (without slip control and electronic stability control) the hydraulic pressure generated by the driver's brake foot via the brake pedal 3 is transmitted to the two rear wheel brakes 1.

According to the example, the electrohydraulic brake control unit 9 is connected via a data bus “sensor-CAN” to a separate sensor cluster module 12 comprising yaw rate and acceleration sensor arrangements. In addition, the electronic control unit 9 is connected via a data bus “vehicle-CAN” to other vehicle control units.

According to the first exemplary embodiment, a respective serial data bus 11 connects the two control units 10 to one another for intercommunication (CAN B), and connects each of the electronic control units 10 to the electrohydraulic control unit 9 (CAN A, CAN C), thus forming a directly connected ring bus circuit. In this way the electrohydraulic brake control unit 9 is connected to each of the electromechanically actuatable wheel brakes 2 via more than one communication path. For example, the brake control unit 9 is connected directly via CAN A and indirectly via CAN C, CAN B to the electronic control units 10 of the left front wheel VL. This ensures redundant data transmission.

According to the example, a parking brake functionality (emergency brake function) is implemented by the front wheel brakes 2. For this purpose the electromechanically actuatable wheel brakes 2 have a parking brake device (not shown) with which the wheel brakes can be locked in the applied state in order to execute parking braking. The electromechanical front wheel actuators 2 serve as a parking brake; that is, the front wheel actuators 2 can lock on the parking brake force when without current.

In the example, the hydraulic rear wheel brakes 1 have no parking brake or emergency brake functionality.

The parking brake function can be activated with the aid of an operating element 5. The operating element 5 may be in the form, for example, of a key switch having three switching positions for the commands “Apply”, “Neutral” and “Release”, only the middle neutral position being a stable switching position.

As shown in FIG. 1, in the example the signal of the parking brake switch 5 is supplied to the electrohydraulic control unit 9 via a signal line 7′. Transmission of the information to the electromechanical brakes 2, which execute the parking brake and emergency brake function, is then possible via the bus system 11.

Alternatively, the signal of the parking brake switch 5 may be supplied directly (not shown) to one or both electromechanical brake control unit(s) 10. In this way parking braking is possible even in the event of failure of the electrohydraulic control unit 9.

In order to determine the braking request of the vehicle driver, the brake system according to the above-described first exemplary embodiment includes a travel sensor 8 for determining brake pedal travel. Alternatively, the driver's braking request may also be determined via an angle sensor 8 for detecting the brake pedal angle. The signal of the sensor 8 is made available directly (for example, via signal lines directly to the electromechanical wheel brakes 2), or indirectly (for example, via the electrohydraulic control unit 9 and the bus system 11) to the electromechanical wheel brakes 2. Direct signal transmission to the electromechanical wheel brakes 2 has the advantage that even in the event of failure of the electrohydraulic brake control unit 9 the driver's braking request is available at the electromechanical wheel brakes 2 and braking can be activated.

Information on, for example, the output signals of the sensors 8 regarding detection of the driver's braking request and of the parking brake operating element 5 are therefore exchanged via the data bus 11.

In the example, the brake system comprises wheel rotational speed sensors 13 on all four wheels VL, HL, VR, HR. Each of the front wheel brakes 2 receives at least the wheel rotational speed signal of a front wheel rotational speed sensor 13 supplied directly to it. Thus, independent braking control by the electronic control unit 10 of the electromechanically actuatable wheel brakes 2 is possible even in the event of failure of the electrohydraulic control unit 9.

Alternatively, the signals of the wheel rotational speed sensors 13 are supplied to the electrohydraulic control unit 9 and are then made available to the electromechanical brakes 2 by the bus system 11.

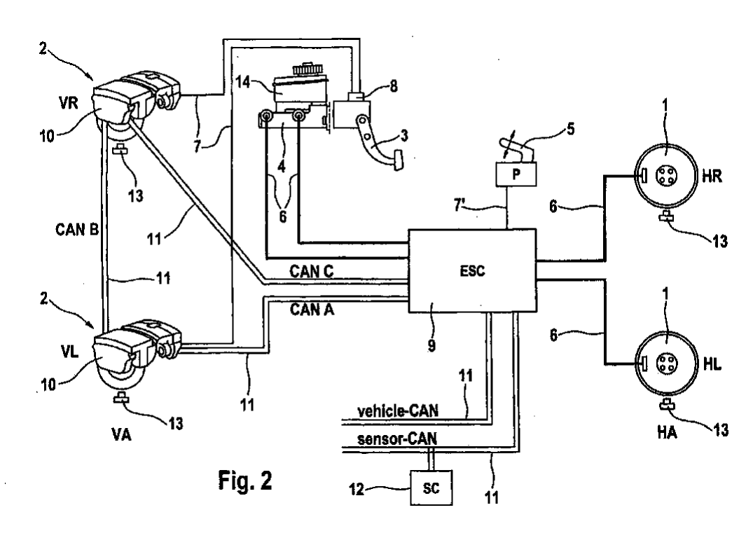

FIG. 2 shows schematically a second exemplary embodiment of a vehicle brake system according to the invention. Mutually corresponding components of the first and second exemplary embodiments are denoted by the same reference symbols. Unlike the first exemplary embodiment, the vehicle brake system according to the second exemplary embodiment includes a tandem brake master cylinder 4 and two hydraulic brake lines 6 to the electrohydraulic control unit 9; the system thus has a dual-circuit configuration. As in the first exemplary embodiment, the electrohydraulic control unit 9 is in the form of a control unit for the electronic stability control system (ESC control unit) which can carry out an autonomous build-up of pressure to the rear axle HA and is connected to the rear wheel brakes 1 via two brake lines 6.

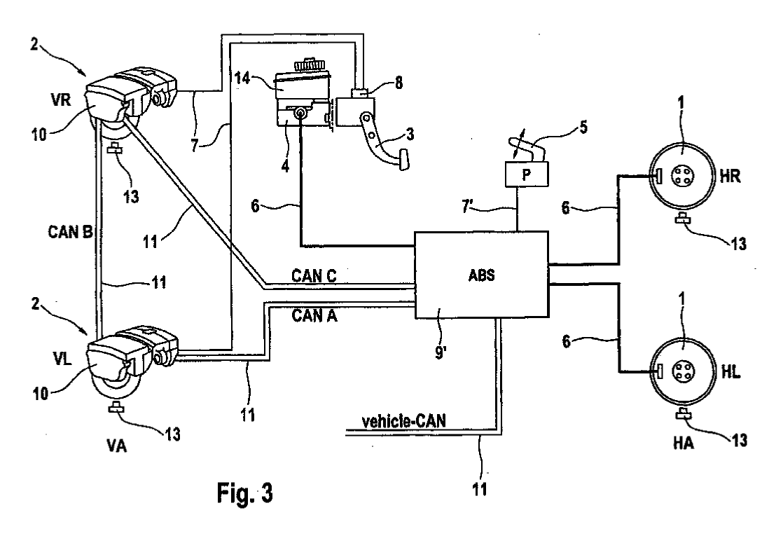

FIG. 3 shows schematically a third exemplary embodiment of a vehicle brake system according to the invention. Mutually corresponding components of the first and third exemplary embodiments are denoted by the same reference symbols. This exemplary embodiment comprises a brake system with a single-circuit hydraulic rear wheel brake system and electromechanically actuatable wheel brakes 2 on the front axle. The hydraulically actuatable rear axle wheel brakes 1 are subjected to hydraulic pressure medium by means of the pedal-actuated master cylinder 4. For this purpose the hydraulically actuatable wheel brakes 1 are connected to the master cylinder 4 via a hydraulic line 6, inlet valves (part of the electrohydraulic control unit 9′) being interposed. During a pressure reduction the pressure medium admitted is discharged via outlet valves (also parts of the electrohydraulic control unit 9′) into an unpressurized pressure medium reservoir 14. In order to determine the hydraulic pressure which has been induced and in order to carry out control processes such as anti-lock controls, at least one pressure sensor is provided in the example.

In this cost-effective variant, the electrohydraulic control unit 9′ is in the form of an ABS control unit (ABS: anti-lock system) having two hydraulic inlet valves and two hydraulic outlet valves for the rear wheels HR, HL, one inlet valve and one outlet valve per wheel.

The ABS control unit 9′, in interaction with the electromechanical front wheel brakes 2, can implement all the essential braking functionalities of present-day high-end brake control units. Only an autarkic pressure build-up to the rear wheels HR, HL—which, however, plays a somewhat minor role in practice—is not possible with this arrangement.

In the above-described exemplary embodiments the brake master cylinder 4 advantageously includes at least one pressure or travel sensor in order to determine a hydraulic pressure or a travel of a piston. This information is made available to at least the electrohydraulic control unit 9, 9′, either directly (for example, via a signal line directly to the electrohydraulic control unit 9), or indirectly (for example, via at least one signal line to at least one electromechanical wheel brake 2 and via the bus system 11 to the electrohydraulic control unit 9, 9′), in order to be available, for example, for slip control. In addition, this information can also be transmitted indirectly or directly to at least one, in particular all, electromechanical wheel brakes 2.

According to a further exemplary embodiment of the invention, at least a signal which represents a measure for the hydraulic pressure induced in the hydraulically actuatable wheel brakes 1 (determined, for example, using a pressure sensor in the electrohydraulic control unit 9, 9′), or a measure for the hydraulic pressure induced by the driver (determined, for example, using an admission pressure sensor or using a piston travel sensor in the master cylinder 4), or a measure for the actuation travel or actuation angle of the brake pedal 3, is supplied to the electromechanical front wheel brakes 2. Advantageously, this signal is supplied directly to the front wheel brakes 2 (for example, via a signal line 7), so that the electronic control units 10 can execute braking autonomously with reference to the signals made available, even in the event of a loss of communication to the electrohydraulic control unit 9, 9′.

In this example, in the event of failure of one of the electromechanical front wheel brakes 2, the second electromechanical front wheel brake 2 continues to be active in the braking process (normal brake or parking brake).

In the example, the electrohydraulic regulation and control unit 9, 9′ is mounted in the rear part of the vehicle. The length of the hydraulic lines 6 is thereby reduced.

Advantageously, the brake fluid reservoir 14 for the electrohydraulic control unit 9, 9′ is likewise mounted in the rear part of the vehicle. In this way additional installation space can be saved in the front part of the vehicle.

The electrohydraulic control unit 9 may indirectly or directly activate at least one vehicle brake light.

A brake system according to the invention is used, for example, in an electric vehicle, since a vacuum of an internal combustion engine for brake boosting is in principle not present in such vehicles.

However, a brake system according to the invention may also be used as a brake system for a hybrid vehicle (electric and internal combustion engine drive), since a vacuum of an internal combustion engine is available only periodically in such vehicles, namely when the internal combustion engine is running.

However, a brake system according to the invention is also suitable for vehicles with at least an internal combustion engine for drive purposes.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1.-16. (canceled)

17. A combined vehicle brake system comprising an electromechanical service brake system for wheels of a front axle of a vehicle and a hydraulic service brake system for wheels of a rear axle of the vehicle, the electromagnetic service brake system having at least one electromechanically actuatable wheel brake, and the hydraulic service brake system having a brake master cylinder and at least one hydraulically actuatable wheel brake.

18. The vehicle brake system according to claim 17, wherein the at least one hydraulically actuatable wheel brake is a self-energizing brake and the at least one electromechanically actuatable wheel brake is a disk brake.

19. The vehicle brake system according to claim 18, wherein the at least one hydraulically actuatable wheel brake is a drum brake.

20. The vehicle brake system according to claim 18, wherein the at least one electromechanically actuatable wheel brake is a disk brake with a first effective radius and the at least one hydraulically actuatable wheel brake is a disk brake with a second effective radius, the second effective radius being larger than the first effective radius.

21. The vehicle brake system according to claim 17, further comprising a hydraulic manual brake actuating device connected to the hydraulic service brake system upstream of the brake master cylinder.

22. The vehicle brake system according to claim 17, further comprising an electrohydraulic control unit associated with the rear axle and configured to control a rear braking force exerted by the at least one hydraulically actuatable wheel brake by actuating a wheel brake pressure control valve arrangement, and to transmit command data to the at least one electromechanically actuatable wheel brake for controlling a front braking force.

23. The vehicle brake system according to claim 22, wherein the electrohydraulic control unit is configured to subject the at least one hydraulically actuatable wheel brake to a hydraulic pressure independent of an actuation of a manual brake actuating device.

24. The vehicle brake system according to claim 22, wherein the hydraulic service brake system is a single-circuit brake system and the brake master cylinder is a single-circuit master cylinder connected to two hydraulically actuatable wheel brakes, the electrohydraulic control unit being connected to the single-circuit master cylinder via a single hydraulic brake line and to each of the two hydraulically actuatable wheel brakes via a respective single hydraulic brake line.

25. The vehicle brake system according to claim 22, wherein the hydraulic service brake system is a dual-circuit brake system and the brake master cylinder is a tandem master cylinder connected to two hydraulically actuatable wheel brakes, the electrohydraulic control unit being connected to the tandem master cylinder via two hydraulic brake lines and to each of the two hydraulically actuatable wheel brakes via a respective single hydraulic brake line.

26. The vehicle brake system according to claim 22, wherein each of the at least one electromechanically actuatable wheel brake is associated with a respective electronic control unit connected via a plurality of communication buses indirectly or directly to the electrohydraulic control unit.

27. The vehicle brake system according to claim 26, wherein each electronic control unit associated with the at least one electromechanically actuatable wheel brake is integral with the respective electromechanically actuatable wheel brake

28. The vehicle brake system according to claim 26, wherein each electronic control unit is directly connected to at least one wheel rotational speed sensor arranged on the wheel associated with the respective wheel brake connected to the electronic control unit.

29. The vehicle brake system according to claim 26, further comprising a sensor detecting a manual braking request and an additional information path from the sensor detecting the manual braking request to each electronic control unit, the additional information path bypassing the electrohydraulic control unit.

30. The vehicle brake system according to claim 17, wherein at least one of the at least one electromechanically actuatable wheel brake includes a parking brake device with a parking brake operating element.

31. The vehicle brake system according to claim 30, wherein the parking brake operating element is connected directly to the electrohydraulic unit.

32. A vehicle with a combined vehicle brake system according to claim 17.

33. The vehicle according to claim 32 with a front and a rear part, further comprising an electrohydraulic control unit and a brake fluid reservoir supplying the electrohydraulic control unit with brake fluid, the electrohydraulic control unit and the brake fluid reservoir being arranged in the rear part of the vehicle.
